(19) United States
(12) Patent Application Publication
(10) Pub. No.: US 2022/0300467 A1
(43) Pub. Date: Sep. 22, 2022

(54) STORAGE MEDIUM, LEARNING DEVICE, AND DATA COLLECTION SYSTEM

(71) Applicant: Mitsubishi Electric Corporation, Tokyo (JP)

(72) Inventor: Masafumi YOKOYAMA, Tokyo (JP)

(73) Assignee: Mitsubishi Electric Corporation, Tokyo (JP)

(21) Appl. No.: 17/633,591

(22) PCT Filed: Sep. 26, 2019
(86) PCT No.: PCT/JP2019/038020

§ 371 Date: Feb. 8, 2022

(51) Int. Cl. G06F 16/21; G06F 16/25

(52) U.S. Cl. CPC G06F 16/211; G06F 16/258

(57) ABSTRACT

An engineering tool includes a device model editing unit and a conversion candidate providing unit. The editing unit edits first correspondence information, based on an instruction. The correspondence information indicates a correspondence between a first device-specific data type of first collection data to be collected from a first device and a first reference data type of first reference data interpretable by a first application. The conversion candidate providing unit learns a conversion rule, based on an editing result of the first correspondence information. The conversion rule is a rule of conversion from the first reference data type to the first device-specific data type. The conversion candidate providing unit estimates, using the conversion rule, conversion candidates for a second device-specific data type of second collection data to be collected from a second device, with respect to a second reference data type of second reference data interpretable by a second application.

### FIELD

The present invention relates to an engineering tool, a learning device, and a data collection system for use in data collection.

### BACKGROUND

In recent years, productivity at production sites has been improved by collecting collection data from industrial equipment installed in production sites using Internet of Things (IoT) technology and feeding back analysis results of the collection data to the production sites.

Production at a production site is typically performed in a multi-vendor environment in which devices such as industrial equipment supplied from different vendors are combined. In addition, these devices often use communication protocols that vary from vendor to vendor. In order to integrally utilize the collection data collected by the IoT platform without depending on the devices or communication protocols, it is necessary to collect data such that externally available data definitions that may differ between devices are provided as a unique data definition to an application that, for example, analyzes the collection data.

In collecting collection data from the devices, thus, it is necessary to associate the data definition of reference data interpretable by the application with the data definition of collection data interpretable by the industrial equipment.

The computer processing device described in Patent Literature 1 uses a mapping rule indicating a correspondence between input data and a concept of electronic data to select the concept of electronic data corresponding to the input data, and captures the structure of the input data with the selected concept. Input data in Patent Literature 1 is data corresponding to reference data interpretable by the application, and a concept of electronic data is data corresponding to collection data.

### CITATION LIST

### Patent Literature

Patent Literature 1: Japanese Patent Application Laid-open No. 2006-178982

### SUMMARY

### Technical Problem

Unfortunately, the technique of Patent Literature 1 can provide the concept of electronic data corresponding to input data with the input data associated in advance with the concept of electronic data, but fails to provide a concept of electronic data for input data unassociated with the concept of electronic data. In a case where the technique of Patent Literature 1 is applied to a data collection system that collects collection data from a device and provides the collection data to an application, input data is reference data interpretable by the application and a concept of electronic data is collection data, as described above. The technique of Patent Literature 1 as applied to the data collection system fails to provide the data type of collection data corresponding to a data type of reference data, unless a conversion rule between data types of reference data interpretable by the application and data types of collection data to be collected from the device is defined in advance.

The present invention has been made in view of the above, and an object thereof is to obtain an engineering tool capable of providing data type candidates for collection data corresponding to a data type of reference data interpretable by an application even when the data type of reference data is not associated with a data type of collection data.

### Solution to Problem

To solve the above-described problems and achieve the object, an engineering tool according to the present invention includes an editing unit to edit first correspondence information on a basis of an instruction from a first user, the first correspondence information indicating a correspondence between a first device-specific data type and a first reference data type, the first device-specific data type being a data type of first collection data to be collected from a first device, the first reference data type being a data type of first reference data interpretable by a first application. The engineering tool according to the present invention also includes a conversion candidate providing unit to learn a conversion rule on the basis of a result of editing of the first correspondence information, the conversion rule being a rule of conversion from the first reference data type to the first device-specific data type, and estimate, using the conversion rule, conversion candidates for a second device-specific data type with respect to a second reference data type, the second device-specific data type being a data type of second collection data to be collected from a second device, the second reference data type being a data type of second reference data interpretable by a second application.

### Advantageous Effects of Invention

The engineering tool according to the present invention can achieve the effect of providing the data type candidates for the collection data corresponding to the data type of reference data interpretable by the application even when the data type of reference data is not associated with the data type of collection data.

### BRIEF DESCRIPTION OF DRAWINGS

FIG. 1 is a diagram illustrating a configuration of a data collection system according to an embodiment.

FIG. 2 is a diagram illustrating a configuration of a conversion candidate providing unit provided in an engineering tool according to the embodiment.

FIG. 3 is a diagram illustrating a configuration of a conversion rule learning unit provided in the engineering tool according to the embodiment.

FIG. 4 is a diagram illustrating a configuration of a neural network that is used by the engineering tool according to the embodiment.

FIG. 5 is a flowchart illustrating an operation procedure for machine learning by the engineering tool according to the embodiment.

FIG. 6 is a flowchart illustrating an operation procedure for data estimation by the engineering tool according to the embodiment.

FIG. 7 is a diagram illustrating a first example of a hardware configuration that implements a computer that operates the engineering tool according to the embodiment.

FIG. 8 is a diagram illustrating a second example of a hardware configuration that implements a computer that operates the engineering tool according to the embodiment.

### DESCRIPTION OF EMBODIMENTS

An engineering tool, a learning device, and a data collection system according to an embodiment of the present invention will be hereinafter described in detail with reference to the drawings. The present invention is not limited to the embodiment.

### Embodiment

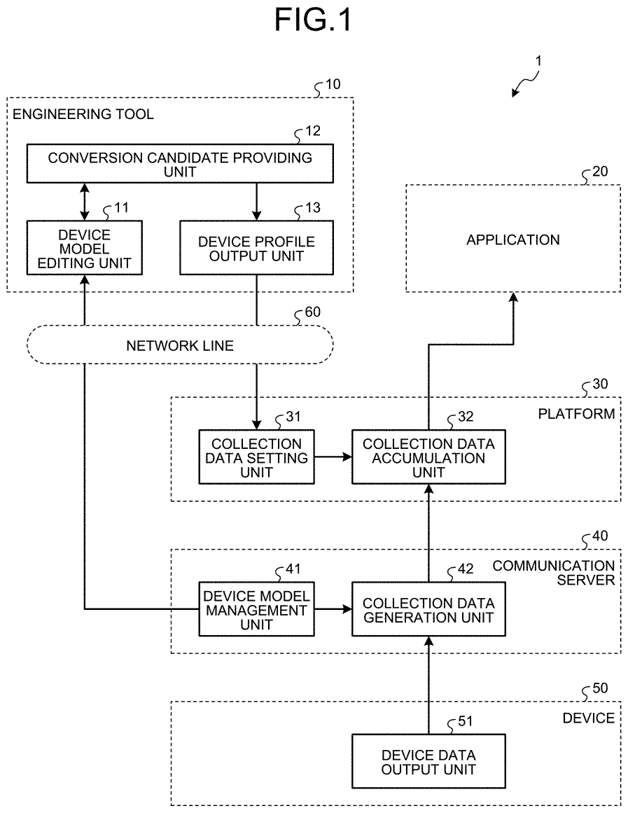

FIG. 1 is a diagram illustrating a configuration of a data collection system according to an embodiment. The data collection system 1 includes an engineering tool 10, an application 20, a platform 30, a communication server 40, a device 50, and a network line 60.

The data collection system 1 is a system that collects device data from various types of equipment and provides the application 20 with collection data generated from the device data. Examples of equipment include a machine tool installed in a production site and a device near the machine tool. The present embodiment describes the device 50 as a piece of equipment from which to collect device data. An example of device data and collection data is operation data indicating the operation status of the device 50 or the like.

Each of the engineering tool 10, the application 20, the platform 30, and the communication server 40 is implemented using, for example, a computer such as a PC (personal computer). Note that the application 20 and the platform 30 may be implemented by the same computer. In addition, the platform 30 and the communication server 40 may be implemented by the same computer.

In the data collection system 1, the platform 30, which is an IoT platform, acquires and accumulates collection data from the device 50 via the communication server 40. The platform 30 acquires collection data on each device 50 and on a communication-protocol-by-communication-protocol basis. Upon request of the application 20 for data collection, the platform 30 provides the application 20 with the collection data.

The engineering tool 10 is a software tool having a function of supporting data collection settings in the platform 30. The engineering tool 10 sends, to the platform 30, collection setting information, i.e. setting information on collection data.

The collection setting information specifies information on collection data that the platform 30 accumulates. The collection setting information includes a data item of data requested by the application 20, and information for identifying the collection data corresponding to the data item in the communication server 40. Examples of information for identifying the collection data in the communication server 40 include the identifier of the data item, the data tag name of the data item, and the address, folder path, or uniform resource locator (URL) of a place where the data item is stored. In addition, the collection setting information includes information in which data types of collection data that the platform 30 accumulates are associated with data types of data handled by the application 20. Such information having these two different date types associated with each other is herein referred to correspondence information as will be described later.

The engineering tool 10 can be used at a location away from the production site where the device 50 is placed, and is connected to the platform 30 and the communication server 40 via the network line 60. Examples of the network line 60 include the Internet and a local area network (LAN).

The engineering tool 10 acquires, from the communication server 40, a schema definition defining the schema of collection data. The schema definition of collection data is information defining a device-specific schema (data model structure), i.e. the schema of collection data handled by the communication server 40. In the following description, the schema definition of collection data handled by the communication server 40 is referred to as the device schema definition. The device schema definition includes identifiers such as data tag names. Collection data handled by the communication server 40 is data interpretable by the communication server 40.

The device-specific schema includes a data model of collection data handled by the communication server 40. The device schema definition therefore includes information defining a data model of collection data. A data model of collection data is a modeled template constituting the device-specific schema.

The application 20 is, for example, a facility operation monitoring application that is introduced for the purpose of improving productivity at a production site. For example, the application 20 visualizes the status of production operation. For example, the application 20 analyzes collection data collected from the device 50, and diagnoses the operation state of the production site or the like. The application 20 performs data processing in accordance with the schema definition of reference data, i.e. data handled by the application 20. The reference data handled by the application 20 is data interpretable by the application 20. The schema definition of reference data is information defining a reference schema, i.e. the schema of reference data handled by the application 20. In the following description, the schema definition of reference data handled by the application 20 is referred to as the reference schema definition. The reference schema definition may include identifiers such as data tag names, or may include the data content of reference data.

The reference schema definition includes a data model of reference data handled by the application 20. The reference schema definition therefore includes information defining a data model of reference data. A data model in the application 20 is a modeled template constituting the reference schema.

The communication server 40 acquires device data from the device 50 and accumulates the acquired device data as collection data. Upon request of the platform 30 for collection data, the communication server 40 transmits the collection data to the platform 30. Examples of the communication server 40 include an MT Connnect and an Object linking and embedding for Process Control Unified Architecture (OPC UA) server. In a case where Edgecross is applied to the data collection system 1, the communication server 40 is accessed from a data collector conforming to various communication protocols.

The device 50 placed at the production site includes a device data output unit 51 for outputting device data such as operation data to an external device. Operation data is state monitoring data with which the application 20 can determine the operation state of the device 50. Examples of operation data include data indicating the operating state of the device 50, the operating mode of the device 50, the processing state of a workpiece, and occurrence or non-occurrence of an alarm.

The communication server 40 includes a device model management unit 41 and a collection data generation unit 42. The device model management unit 41 manages the device schema definition. The device model management unit 41 manages, for example, an Extensible Markup Language (XML) document or the like in order to manage the device schema definition. In the XML document, data items are described line by line. The data items are each given a data type that characterizes the device schema.

A data type is information indicating the content of collection data. That is, a data type is information defining the category, classification, or content of collection data. In other words, a data type is a defined name of collection data. Examples of a data type include coordinates, the number of work counts, and program name.

The device model management unit 41 stores the device schema definition described in the XML document, and provides the device schema definition to the engineering tool 10 upon request of the engineering tool 10.

The collection data generation unit 42 collects device data from the device 50 on the basis of the device schema definition stored in the device model management unit 41. The collection data generation unit 42 generates collection data from the device data on the basis of the device schema definition. Specifically, upon receiving device data from the device data output unit 51, the collection data generation unit 42 shapes, on the basis of the device schema definition of the device 50, the device data into collection data in output format conforming to the communication protocol. The communication protocol as used herein is the communication protocol used between the platform 30 and the communication server 40. In response to request of the platform 30, the collection data generation unit 42 outputs, to the platform 30, the collection data generated through the shaping. Note that the collection data generation unit 42 can output the generated collection data to the application 20 in response to request of the application 20.

Data models of data generally used in communication devices for industrial use are largely determined by the device kind of the device 50, the device vendor which is the vendor of the device 50, and the communication protocol. These data models are defined by the device schema definition held in the communication server 40. In the device schema definition, a data model adapted to each device 50 is structurally defined by an XML document or the like according to the data model meta-structure specified in the communication protocol. Specifically, in the device schema definition, a data model is structurally defined in which each data item to be collected is associated with its basic attribute information such as the tag name or data identifier (identification (ID) information), data type, subtype, data form, and unit. Subtype is used to further classify a data type. When the data type is coordinates, examples of the subtype include workpiece coordinates and machine coordinates. Data form is the form of the programming language of collection data, and exemplified by character string, integer, and date.

Note that although, some case, a plurality of data models (device models) is defined in one device-specific schema, it is necessary to ensure that the individual data identifiers of data items included in the data models are basically not redundant. Although basic attribute information such as data identifiers is semantically defined in the communication protocol, interpretation of the data model and application-level connectivity in the actual product often depend on the vendor implementation. For this reason, it is generally believed that there is no strict solution to which device data should be associated with a data type or a subtype. Application-level connectivity indicates whether data communication connection maintaining data content is possible.

Information that differs in device schema definition between vendors is, for example, information on execution lines of an unattended operation program for a machine tool. In an unattended operation program for a machine tool, information for identifying the content of the unattended operation program regardless of the vendor of the numerical control (NC) device is represented by program name, sequence number, block number, and the like. These pieces of information are utilized by the NC device as information for the search of the start position of unattended operation or editing lines, for example. Both sequence number and block number are information by which program lines are identifiable.

In some communication protocol, program name or program line may be the only data type representing line number. In this case, whereas the reference schema may define program line as block number, some vendor (Vendor A) may want to define the data type of program line as sequence number. In addition, another vendor (Vendor B) may want to define the data type of program line as an extended data type. Even though the device schema definitions handled by the communication server 40 may specify the same data type, therefore, it is possible that the different contents of collection data may be collected from the different devices 50. That is, in some case, the content of data defined by the application 20 in the reference schema definition is different from the content of data defined by each vendor in the device schema definition.

Moreover, instead of standard data types defined in the communication protocol, extended definitions in a way customized by a device vendor may be applied. In these cases, even though Vendor A's device and Vendor B's device may use the same data type meaning program line, it is possible that Vendor A's data type may indicate a data item representing block number, whereas Vendor B's data type may indicate a data item representing sequence number. That is, the correspondence between a data type and the content of data (meaning of data) is variously set. For this reason, it is impossible for the application 20 to handle the device data of Vendor A and the device data of Vendor B as the same data, relying on data types.

The platform 30 includes a collection data setting unit 31 and a collection data accumulation unit 32. The collection data setting unit 31 receives, from the engineering tool 10, collection setting information on the collection data to be accumulated, and manages the received collection setting information. The collection setting information specifies data types (hereinafter referred to as device-specific data types) of the device-specific schema corresponding to data types (hereinafter referred to as reference data types) of the reference schema. That is, in the collection setting information, the reference data type assigned to a data item of reference data and the device-specific data type assigned to a data item of device-specific data are associated with each other. Specifically, in the collection setting information, the identifier of a data item corresponding to a reference data type and the identifier of a data item corresponding to a device-specific data type are associated with each other. Note that in the collection setting information, a data item of a reference data type and the identifier of a data item corresponding to a device-specific data type can be associated with each other.

Once the application 20 designates a specific reference data type as a collection target, the collection data accumulation unit 32 extracts, from the collection setting information, the device data type corresponding to the designated reference data type. The collection data accumulation unit 32 requests collection data of the extracted device data type from the collection data generation unit 42 of the communication server 40. For example, the collection data accumulation unit 32 transmits the identifier of the data item of the device data type to the collection data generation unit 42 to request collection data corresponding to the identifier from the collection data generation unit 42. In this manner, the collection data accumulation unit 32 requests collection data from the collection data generation unit 42 in accordance with the collection setting information.

The collection data accumulation unit 32 receives and accumulates the collection data sent from the collection data generation unit 42. The collection data accumulation unit 32 delivers the accumulated collection data to the application 20 in response to request of the application 20. The data types of the collection data that the collection data accumulation unit 32 delivers basically conform to the definition of data types or subtypes that can be handled by the application 20. The collection data accumulation unit 32 transmits the collection data to the application 20, using a general-purpose communication protocol.

The engineering tool 10 includes a device model editing unit 11, a conversion candidate providing unit 12, and a device profile output unit 13. The device model editing unit 11 acquires, from the device model management unit 41 of the communication server 40, the device schema definition including device-specific data types. Device-specific data types are used for editing correspondence information indicating a correspondence between device-specific data types and reference data types.

The device model editing unit 11 edits the correspondence information by editing device-specific data types in the device schema definition. The correspondence information is edited at the device model editing unit 11 by the user inputting an editing instruction to the device model editing unit 11. The user edits the correspondence information with reference to system information (information on the device 50, application kind, and communication protocol kind) to be described later.

The correspondence information is information indicating which data item identifier in the device-specific schema should be collected from the communication server 40 with respect to the identifier of a data item that needs converting in the reference schema. In other words, the correspondence information is information indicating a correspondence between the reference schema definition and the device schema definition, that is, information indicating a correspondence between schema definitions.

The device model editing unit 11 edits the correspondence information by editing a device model or the like included in the device schema definition on the basis of an operation by the user. The platform 30 needs to collect, from the device 50, collection data that match the data type of each data item defined in the reference schema definition.

In some case, a reference schema for reference data generally required by an application has data representing a meaning similar or identical to that of a device-specific schema, but has a data type definition different from that of the device-specific schema, as described above. In such a case, on the premise that the application is not to be modified, it is conventionally necessary for a system integrator who is familiar with specifications of both the reference schema definition and the device schema definition to change the device schema definition that is used in the communication server and the collection setting information that is used in the platform. Specifically, it is conventionally necessary for a system integrator or the like to change the device schema definition for the communication server and change the collection setting information for the platform such that collection data that match the data type required by the application is collected from the device.

In the present embodiment, the user edits the correspondence information, using the device model editing unit 11 with reference to the data type, subtype, or the like of a data item that needs converting between the reference schema and the device-specific schema. At this time, the user edits the correspondence information by editing the device schema definition (device model or the like) corresponding to the reference schema definition with reference to the information learned from the result of the editing of the correspondence information.

The user can input the reference schema definition to the device model editing unit 11, or the device model editing unit 11 can acquire the reference schema definition from an external device such as the application 20. As described above, the correspondence information is information indicating a correspondence between data types. When it is necessary to collect the device data of Vendor A in the case of the unattended operation program in the machine tool, for example, the device model editing unit 11 must conduct mapping definition on not the data item of sequence number, but the data identifier of the data item representing block number for program line in the reference schema.

The device model editing unit 11 sends, to the conversion candidate providing unit 12, the editing result including the edited content of the correspondence information. The conversion candidate providing unit 12 transmits, to the device profile output unit 13, the correspondence information in which the device-specific data type of each data item of collection data is mapped to a reference data type.

In addition, the conversion candidate providing unit 12 learns a conversion rule, using the information used for editing the correspondence information and the editing result of the correspondence information. In other words, the conversion candidate providing unit 12 learns the conversion rule on the basis of the history of editing of the correspondence information by the user. The conversion rule is a rule of conversion from reference data types to device-specific data types. That is, the conversion rule is a rule for associating reference data types with device-specific data types. Thus, learning the conversion rule corresponds to learning candidates for the device-specific data type (conversion candidates to be described later) corresponding to a reference data type.

In the following description, information used for editing the correspondence information is referred to as system information. The system information includes at least one of “device information” which is information on the device 50, “application kind” which is the kind of the application 20, and “communication protocol kind” which is the kind of the communication protocol between the communication server 40 and the platform 30. The “device information” includes at least one of “device manufacturer kind” which is the kind of the device manufacturer that manufactured the device 50, “device kind” which is the kind of the device 50, and “device configuration” which is the configuration of the device 50. The editing result of the correspondence information is a result of association between reference data types and device-specific data types.

The “device information”, “communication protocol kind”, and “application kind” are input to the conversion candidate providing unit 12 by the user, for example. Note that the conversion candidate providing unit 12 can extract at least one of the “device information” and the “communication protocol kind” from the device schema definition. In addition, the conversion candidate providing unit 12 can acquire the “application kind” from the application 20.

The conversion candidate providing unit 12 observes system information and reference data types as state variables. In addition, the application 20 acquires training data. Then, the conversion candidate providing unit 12 learns the conversion rule in accordance with the data set created based on combinations of the state variables and the training data. The training data is the device-specific data types associated with reference data types by the user. In the following description, the device-specific data types associated with reference data types by the user are referred to as “converted data types”. The “converted data types” as the training data are the device-specific data types (data type conversion results) practically set by the user to correspond to reference data types.

Because the device model editing unit 11 edits the device model, the correspondence information includes the edited device model (edited model). The conversion candidate providing unit 12 learns conversion candidates, or the conversion rule that makes it possible to output device-specific data types having the content identical or similar to the content of reference data types.

The conversion candidate providing unit 12 observes the state variables for each device 50, for each communication protocol between the communication server 40 and the platform 30, or for each application 20. The conversion candidate providing unit 12 observes the state variables from, for example, the device schema definition acquired from the device model management unit 41 and the edited content in the device model editing unit 11. That is, the conversion candidate providing unit 12 observes, for example, “device information”, “application kind”, and “communication protocol kind”, which are system information, as state variables.

In addition, the conversion candidate providing unit 12 observes, as state variables, reference data types set in the correspondence information. That is, the conversion candidate providing unit 12 observes, as state variables, reference data types in the correspondence information, i.e., data type conversion results (mapping results) in the device model editing unit 11.

Using the conversion rule obtained as the result of the learning, the conversion candidate providing unit 12 calculates candidates (hereinafter referred to as conversion candidates) for the device-specific data type to be associated with a reference data type. In other words, the conversion candidate providing unit 12 according to the present embodiment calculates candidates (conversion candidates) for a device-specific data type to be set in the correspondence information on the basis of the editing result history of the correspondence information. The correspondence information including device data types mapped to reference data types includes identifiers such as data tag names that allow the application 20 to identify each piece of collection data for each data item. In the correspondence information, the identifiers of data items of collection data handled by the communication server 40 are associated with the identifiers of data items of data handled by the application 20. Among the identifiers included in the correspondence information, the identifiers of data items handled by the communication server 40 are identifiers included in the device-specific schema, and the identifiers of data items handled by the application 20 are identifiers included in the reference schema.

When the reference data type to be mapped is designated by the user, the conversion candidate providing unit 12 estimates conversion candidates corresponding to the designated reference data type. The conversion candidate providing unit 12 estimates conversion candidates on the basis of the learned conversion rule. A conversion candidate is a device-specific data type that is a conversion candidate for the reference data type. In other words, a conversion candidate is a conversion candidate for the data type of the device-specific schema to be associated with the reference schema. The conversion candidate providing unit 12 sends the conversion candidates to the device model editing unit 11.

When the correspondence information for output is sent from the device model editing unit 11, the conversion candidate providing unit 12 outputs this correspondence information to the device profile output unit 13.

The device profile output unit 13 generates collection setting information, using the correspondence information. The device profile output unit 13 converts the protocol of the collection setting information as necessary, and sends the resulting collection setting information to the collection data setting unit 31 of the platform 30.

The engineering tool 10 causes a display device (not illustrated) such as a liquid crystal monitor to display the device schema definition, device-specific data types, system information, reference schema definition, reference data types, conversion rule, editing result of correspondence information, conversion candidates, and the like.

The user edits the correspondence information with reference to the conversion candidates displayed on the display device. In the data collection system 1, editing of the correspondence information by the user and learning of the conversion rule by the engineering tool 10 are repeated.

With such a configuration, the engineering tool 10 can provide conversion candidates corresponding to a reference data type even to a user who lacks knowledge of both reference data types and device-specific data types.

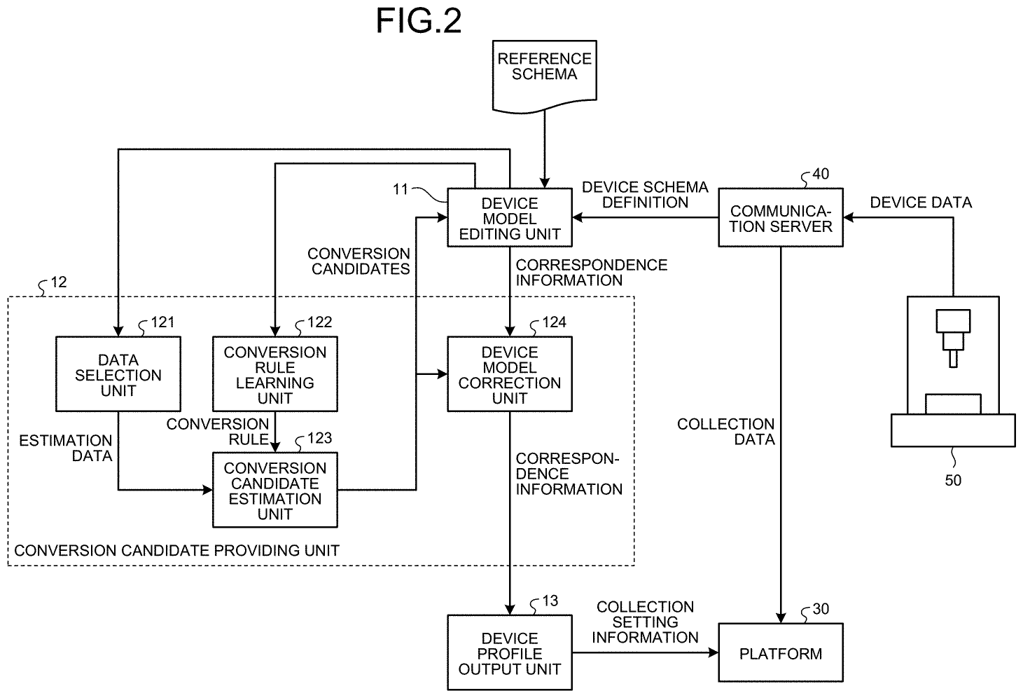

Next, a detailed configuration of the conversion candidate providing unit 12 will be described. FIG. 2 is a diagram illustrating a configuration of the conversion candidate providing unit provided in the engineering tool according to the embodiment. The conversion candidate providing unit 12 includes a data selection unit 121, a conversion rule learning unit 122, a conversion candidate estimation unit 123, and a device model correction unit 124.

The data selection unit 121, the conversion rule learning unit 122, the conversion candidate estimation unit 123, and the device model correction unit 124 are connected to the device model editing unit 11. The conversion candidate estimation unit 123 is connected to the data selection unit 121, the conversion rule learning unit 122, and the device model correction unit 124. The device model correction unit 124 is connected to the device profile output unit 13.

When the correspondence information is edited by the user, the device model editing unit 11 sends the edited correspondence information to the device model correction unit 124. In addition, when the conversion candidate providing unit 12 learns a conversion rule (conversion candidates), the device model editing unit 11 sends, to the conversion rule learning unit 122, the correspondence information indicating the editing result. In addition, when the conversion candidate providing unit 12 estimates conversion candidates, the device model editing unit 11 sends, to the data selection unit 121, the correspondence information being edited. In addition, the device model editing unit 11 acquires, from the conversion candidate providing unit 12, the conversion candidates (denoted by “conversion candidates” in FIG. 2).

The conversion rule learning unit 122, which is a machine learning device, observes system information and reference data types as state variables, and learns a conversion rule that is a learning model on the basis of the state variables and converted data types. By using the conversion result of data types of the device-specific schema with respect to the reference schema, the conversion rule learning unit 122 learns the data type conversion rule adapted to the device 50. The conversion rule learning unit 122 outputs the learned conversion rule to the conversion candidate estimation unit 123.

When the conversion candidate estimation unit 123 estimates conversion candidates corresponding to a reference data type, the data selection unit 121 acquires, from the device model editing unit 11, edit information indicating the state of editing in the device model editing unit 11.

The edit information that the data selection unit 121 acquires from the device model editing unit 11 includes system information and the reference data types being edited with respect to the reference schema. From the edit information, the data selection unit 121 selects and extracts a reference data type to be mapped to a device-specific data type. The reference data type to be mapped to a device-specific data type is a reference data type having different data type content or a different data tag name from the device-specific data type.

The reference data type and the system information that the data selection unit 121 acquires from the device model editing unit 11 are information similar to the state variables that a state observation unit (described later) observes. The system information and the reference data type extracted by the data selection unit 121 are hereinafter referred to as estimation data. The data selection unit 121 outputs the estimation data to the conversion candidate estimation unit 123.

On the basis of the conversion rule, namely, the learning model output from the conversion rule learning unit 122, and the estimation data output from the data selection unit 121, the conversion candidate estimation unit 123 estimates conversion candidates that should be collected from the device 50. The conversion candidate estimation unit 123 can estimate conversion candidates for a device different from the device 50 used for learning the conversion rule. In addition, the conversion candidate estimation unit 123 can estimate conversion candidates for an application different from the application 20 used for learning the conversion rule. The conversion candidate estimation unit 123 outputs the estimated conversion candidates to the device model editing unit 11 and the device model correction unit 124.

On the basis of the conversion candidates sent from the conversion candidate estimation unit 123 and the correspondence information sent from the device model editing unit 11, the device model correction unit 124 determines whether there is a defect such as unedited content in the device model editing unit 11. When there is an editing defect in the device model editing unit 11, the device model correction unit 124 automatically corrects the correspondence information, and outputs the automatically corrected correspondence information to the device profile output unit 13. An example of an editing defect is a lack of a device data type in the correspondence information.

The content of the device schema definition in the present embodiment is generally determined by the combination of the kind of the device 50 for identifying collectable collection data, the kind of the application 20 for identifying the collection data to be utilized, the vendor of the device 50, the vendor of the application 20, and the kind of the communication protocol.

Originally, mapping is required between data items in the device-specific schema and data items in the reference schema. In the present embodiment, the engineering tool 10 observes, as state variables, “device information” such as “device manufacturer kind”, “device kind”, and “device configuration” for characterizing the device-specific schema, “application kind” for characterizing the reference schema, “communication protocol kind” for identifying the device-specific schema, and the like. Consequently, the engineering tool 10 can improve the accuracy of learning the conversion rule for use in the process of estimating conversion candidates, and thus can teach appropriate conversion candidates for a device-specific data type to the user.

Users are classified as a first user who edits the correspondence information before the conversion rule is learned and a second user who edits the correspondence information on the basis of the estimated conversion candidates.

The devices 50 are classified as a first device from which the conversion rule is learned and a second device for which conversion candidates are estimated. The data to be collected from the first device are called first collection data, and the data to be collected from the second device are called second collection data.

The applications 20 are classified as a first application from which the conversion rule is learned and a second application for which conversion candidates are estimated. The reference data interpretable by the first application are called first reference data, and the reference data interpretable by the second application are called second reference data.

The correspondence information edited by the first user is called first correspondence information, and the correspondence information edited by the second user is called second correspondence information. The first correspondence information includes first device-specific data types and first reference data types associated with the first device-specific data types, and the second correspondence information includes second device-specific data types and second reference data types associated with the second device-specific data types.

The system information used for editing the first correspondence information is called first system information, and the system information used for editing the second correspondence information is called second system information. The information included in the first system information is first device information, the kind of the first application, and the kind of the first communication protocol. The information included in the second system information is second device information, the kind of the second application, and the kind of the second communication protocol.

Note that the first user and the second user can be different users or be the same user. Similarly, the first device and the second device can be different devices or be the same device. Similarly, the first application and the second application can be different applications or be the same application.

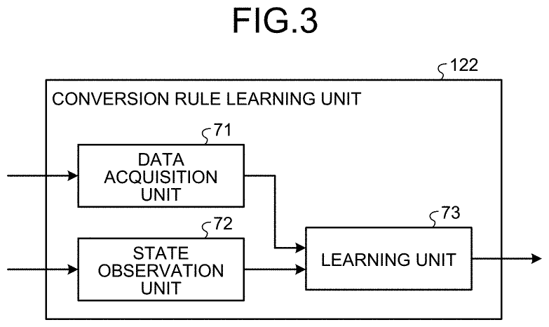

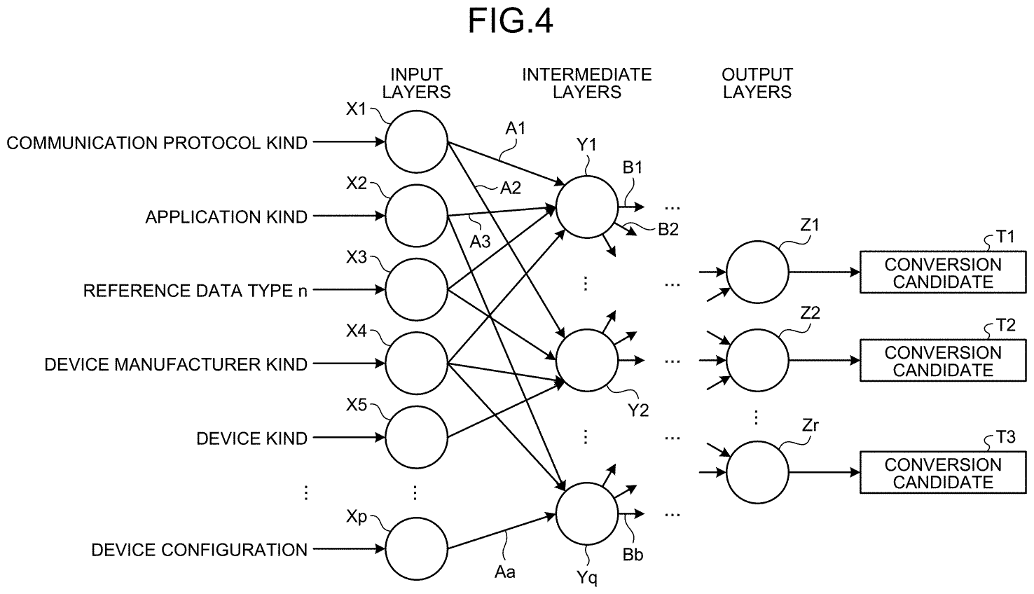

FIG. 3 is a diagram illustrating a configuration of the conversion rule learning unit provided in the engineering tool according to the embodiment. FIG. 4 is a diagram illustrating a configuration of a neural network that is used by the engineering tool according to the embodiment.

The conversion rule learning unit 122 includes a data acquisition unit 71, a state observation unit 72, and a learning unit 73. The data acquisition unit 71 acquires training data from the device model editing unit 11. The training data is the device-specific data types included in the edited correspondence information (the result of the editing of the correspondence information), that is, converted data types. The data acquisition unit 71 transmits the training data to the learning unit 73.

The state observation unit 72 acquires system information from the device model editing unit 11, and extracts reference data types from the edited correspondence information. The state observation unit 72 observes the system information and the reference data types as state variables. The state observation unit 72 transmits the system information and the reference data types to the learning unit 73.

The learning unit 73 learns a conversion rule for deriving conversion candidates (learning results) on the basis of the data set created based on combinations of the training data, namely, the converted data types and the system information and reference data types output from the state observation unit 72. The data set is data in which the state variables and the training data are associated with the state variables.

Note that the conversion rule learning unit 122 is not limited to the one provided in the engineering tool 10. The conversion rule learning unit 122 can be provided in a device outside the engineering tool 10. The conversion rule learning unit 122 can be provided in a device connectable to the engineering tool 10 via the network line 60. That is, the conversion rule learning unit 122 can be a separate component connected to the engineering tool 10 via the network line 60. Alternatively, the conversion rule learning unit 122 can exist on a cloud server.

Through what is called supervised learning according to a neural network model, for example, the conversion rule learning unit 122 learns conversion candidates on the basis of the data types (device data types) of the device model included in the device schema definition collected from the communication server 40. Supervised learning refers to a model that provides a machine learning device with a large number of input-result (label) data pairs to learn features obtained from those data sets and estimate results from inputs.

The neural network includes input layers X1 to Xp (“p” is a natural number) made up of a plurality of neurons, intermediate layers (hidden layers) Y1 to Yq (“q” is a natural number) made up of a plurality of neurons, and output layers Z1 to Zr (“r” is a natural number) made up of a plurality of neurons. The number of intermediate layers Y1 to Yq can be one or be two or more. The input layers X1 to Xp are connected to the intermediate layers Y1 to Yq, and the intermediate layers Y1 to Yq are connected to the output layers Z1 to Zr. Note that the connection between the input layers X1 to Xp and the intermediate layers Y1 to Yq illustrated in FIG. 4 is an example, and each of the input layers X1 to Xp can be connected to any of the intermediate layers Y1 to Yq. In addition, the connection between the intermediate layers Y1 to Yq and the output layers Z1 to Zr illustrated in FIG. 4 is an example, and each of the intermediate layers Y1 to Yq can be connected to any of the output layers Z1 to Zr.

For example, in the case of the three-layer neural network illustrated in FIG. 4, a plurality of inputs are provided to the input layers X1 to Xp, and the values thereof are multiplied by weights A1 to Aa (“a” is a natural number) for input to the intermediate layers Y1 to Yq. The values input to the intermediate layers Y1 to Yq are further multiplied by weights B1 to Bb (“b” is a natural number) for input to the output layers Z1 to Zr and output from the output layers Z1 to Zr. The output results are denoted by conversion candidates T1 to T3. The output results vary depending on the values of the weights A1 to Aa and B1 to Bb.

The neural network according to the present embodiment learns the conversion rule through what is called supervised learning according to the data set created based on combinations of the converted data types acquired by the data acquisition unit 71 and the system information and reference data types observed by the state observation unit 72.

Specifically, the neural network learns by adjusting the weights A1 to Aa and B1 to Bb such that outputs from the output layers Z1 to Zr with the system information and reference data types input to the input layers X1 to Xp approach the converted data types.

The information input to the input layers X1 to Xp is, for example, “communication protocol kind”, “application kind”, “reference data type n” (“n” is a natural number), “device manufacturer kind”, “device kind”, and “device configuration”.

Examples of the “application kind” include operation monitoring applications, process management applications, quality management applications, and maintenance applications. Examples of the “device kind” include machining centers, combined machines, laser machines, and spark eroding machines. Examples of the “device configuration” include the number of systems, axis information, and peripheral equipment. A “conversion candidate” is a “device data type” that is likely to be associated with a “reference data type”.

Upon receiving new system information and a new reference data type, the conversion candidate providing unit 12 calculates conversion candidates, using the learned conversion rule (neural network illustrated in FIG. 4 or the like).

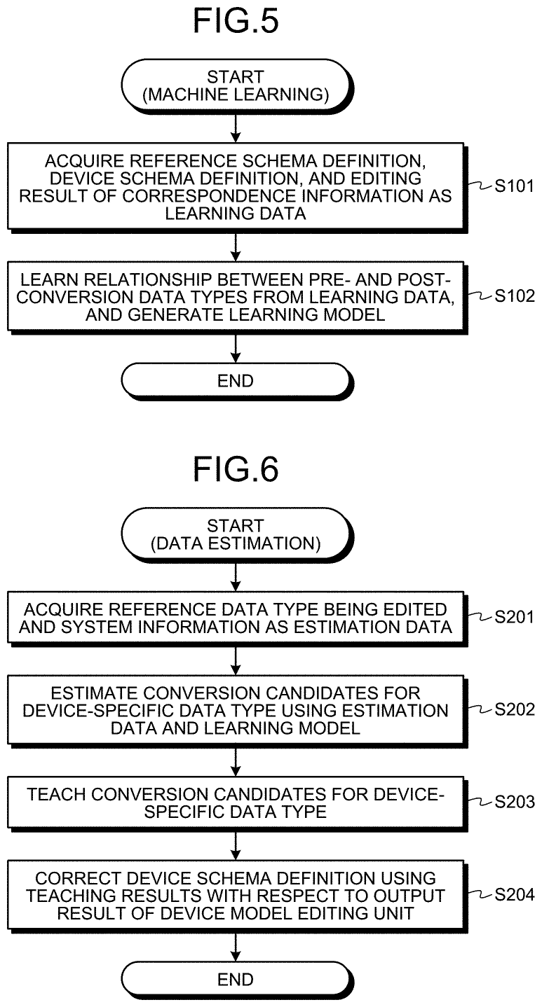

FIG. 5 is a flowchart illustrating an operation procedure for machine learning by the engineering tool according to the embodiment. The conversion rule learning unit 122 acquires learning data. Specifically, the conversion rule learning unit 122 acquires, from the device model editing unit 11, the reference schema definition, the device schema definition, and the result of the editing of the correspondence information by the user, as learning data (step S101).

The conversion rule learning unit 122 learns the relationship between pre- and post-conversion data types from the learning data, and generates a learning model that is a conversion rule (step S102). The relationship between pre- and post-conversion data types is the correspondence information indicating a correspondence between reference data types and device-specific data types. The conversion rule learned by the conversion rule learning unit 122 is a learning model that can estimate conversion candidates collectable from the device 50 with respect to the reference data types interpretable by the application 20. The conversion rule learning unit 122 learns the conversion rule on the basis of the learning data through supervised learning, for example.

The neural network can also learn conversion candidates through what is called unsupervised learning. Unsupervised learning is a technique for providing a machine learning device with a large amount of input data alone to learn how the input data are distributed and learn by performing compression, classification, shaping, or the like on the input data without corresponding training data (output data). In the unsupervised learning, features in a data set can be clustered by similarity, for example. In the unsupervised learning, using the result of this clustering, output allocation is performed in a manner that optimizes some criteria, whereby output prediction can be implemented. A type of problem setting intermediate between unsupervised learning and supervised learning is what is called semi-supervised learning. Semi-supervised learning is a type of learning in which some data are input-output pairs and the remaining data are inputs alone.

The learning unit 73 can also use deep learning as a learning algorithm, which learns feature extraction directly. Alternatively, the learning unit 73 can execute machine learning in accordance with another known method, e.g. genetic programming, functional logic programming, a support vector machine, or the like.

Next, the process in which the engineering tool 10 calculates conversion candidates, using the conversion rule will be described. FIG. 6 is a flowchart illustrating an operation procedure for data estimation by the engineering tool according to the embodiment.

The data selection unit 121 acquires, from the device model editing unit 11, a reference data type being edited in the device model editing unit 11 and system information, as estimation data (step S201). The reference data type being edited is a reference data type unassociated with (unconverted to) a device-specific data type. The data selection unit 121 outputs the estimation data to the conversion candidate estimation unit 123.

The conversion candidate estimation unit 123 receives the estimation data output from the data selection unit 121. The conversion candidate estimation unit 123 also receives the conversion rule that is the learning model output from the conversion rule learning unit 122.

The conversion candidate estimation unit 123 estimates conversion candidates for the device-specific data type, using the estimation data and the learning model (step S202). An example of the learning model is the neural network illustrated in FIG. 4, and the estimation data is input to the input layers X1 to Xp of the neural network. That is, the system information such as the communication protocol kind and the application kind is input to the input layers X1 to Xp of the neural network. The data output from the output layers Z1 to Zr of the neural network is conversion candidates.

The conversion candidate estimation unit 123 teaches the conversion candidates to the device model editing unit 11 that is editing the reference data type (step S203). That is, the conversion candidate estimation unit 123 teaches the conversion candidates, which are data collectable from the device 50, to the device model editing unit 11 that is editing the device-specific data type (data model of the device 50) to be adapted to the reference data type. Specifically, the conversion candidate estimation unit 123 sends the estimated conversion candidates to the device model editing unit 11. The user inputs, to the device model editing unit 11, a selection instruction to select a desired device-specific data type from among the conversion candidates. In accordance with the selection instruction, the device model editing unit 11 associates the device-specific data type with the reference data type being edited. Consequently, the device model editing unit 11 edits the correspondence information.

In this manner, in the case where a plurality of conversion candidates are taught, the user's selection operation is reflected in the device model editing unit 11. The conversion rule learning unit 122 performs what is called reinforcement learning, for example, provides a positive rating for the conversion candidate selected by the user or provides a negative rating for the candidate not selected. That is, the conversion rule learning unit 122 relearns the conversion rule, using the device-specific data type selected by the user. Consequently, the conversion rule learning unit 122 can provide the conversion rule conforming to the practical use frequency of device-specific data types.

The device model editing unit 11 sends the correspondence information edited by the user to the device model correction unit 124. In addition, the conversion candidate estimation unit 123 sends the conversion candidates to the device model correction unit 124.

The device model correction unit 124 corrects the device schema definition, using the conversion candidates, which are the teaching results, with respect to the correspondence information, which is the output result of the device model editing unit 11 (step S204). For example, when there is a defect in the editing operation by the device model editing unit 11 such as undefined content in the device schema definition, the device model correction unit 124 automatically corrects the defective device schema definition to the device schema definition conforming to the appropriate conversion rule. The device model correction unit 124 outputs, to the device profile output unit 13, the correspondence information containing the device schema definition corrected as necessary.

The device profile output unit 13 generates collection setting information including the correspondence information. The device profile output unit 13 converts the protocol of the collection setting information as necessary, and sends the resulting collection setting information to the collection data setting unit 31 of the platform 30. Consequently, the collection data setting unit 31 sets the collection setting information. Then, upon request of the application 20 for data, the collection data accumulation unit 32 of the platform 30 requests the date from the communication server 40 in accordance with the collection setting information. Specifically, the collection data accumulation unit 32 takes the data requested by the application 20, as data of a reference data type, and requests, from the communication server 40, data of the device-specific data type corresponding to this reference data type. The collection data accumulation unit 32 acquires data of the device-specific data type from the communication server 40 by transmitting the identifier of the device-specific data type to the communication server 40. The collection data accumulation unit 32 transmits the acquired data of the device-specific data type to the application 20.

With these mechanisms, the user of the engineering tool 10 according to the present embodiment can configure data collection settings adapted to the data model of the application 20 on the platform 30 without knowing the specifications of the reference schema definition in the application 20 (data model in the application 20) and the specifications of the device schema definition in the device 50 (data model in the device 50).

The platform 30 can collect collection data such that device schema definitions (definitions of data externally available) that may differ by “device information”, “communication protocol kind”, or “application kind” are provided as a unique data definition to the application 20. This enables the application 20 to integrally utilize the collection data collected by the platform 30 without depending on the “device information”, “communication protocol kind”, “application kind”, or the like.

In general, in the case of data matching between an application and devices in an IoT platform or a communication server, configuration work for each device is performed at the production site, with data specifications of both the device and the application taken into consideration. This work requires significant man-hours that vary by system scale, and causes a great problem especially when handling a communication protocol that is not supported by a configuration tool. In addition, in the case of data matching between an application and devices in an IoT platform or a communication server, configuration is collectively performed as part of the system construction work with the intervention of a system integrator who is familiar with data specifications of both the devices and the application. This is problematic in terms of high cost for system construction or long startup time.

In contrast, in the present embodiment, because the engineering tool 10 estimates conversion candidates, the user can easily edit the correspondence information in a short time. The data collection system 1 is therefore constructed at low cost and in a short time.

Note that the data collection system 1 can be applied to data utilization in an IT system layer higher than the application 20, such as a manufacturing execution system (MES) or an enterprise resource planning (ERP). In addition, the data collection system 1 can be applied to data analysis by edge computing in the vicinity of a production site, and diagnosis results of edge computing may be fed back to the device 50 in real time. Consequently, the data collection system 1 can raise the operating rate of production equipment.

As described above, according to the embodiment, the engineering tool 10 learns a conversion rule on the basis of the editing result of the correspondence information, and estimates, using the conversion rule, conversion candidates for a device-specific data type with respect to a reference data type interpretable by the application 20. It is therefore possible to provide the conversion candidates for the device-specific data type corresponding to the reference data type interpretable by the application 20. Thus, even when the reference data type interpretable by the application 20 is not associated with a device-specific data type, it is possible to provide the conversion candidates corresponding to the reference data type.

Because the data collection system 1 can automatically configure data collection settings in the platform 30 on the basis of the learned conversion rule, the effort of data conversion work in the platform 30 is saved. The data collection system 1 may need to connect to new devices or support an increasing number of communication protocols, in which case the prompt connection setting and the system construction can be performed with no need for modification in the application 20.

In addition, because the engineering tool 10 is separated from the platform 30, the engineering tool 10 can edit and output the conversion rule for collection data even at a location remote from the device 50. Therefore, the data collection system 1 can flexibly assign roles in setup work to vendors, which can reduce the system construction cost and shorten the system startup time.

In addition, the device schema definition corresponding to the conversion rule can be output as a device profile in a standard modeling description language, and thus can be applied to various industrial platforms.

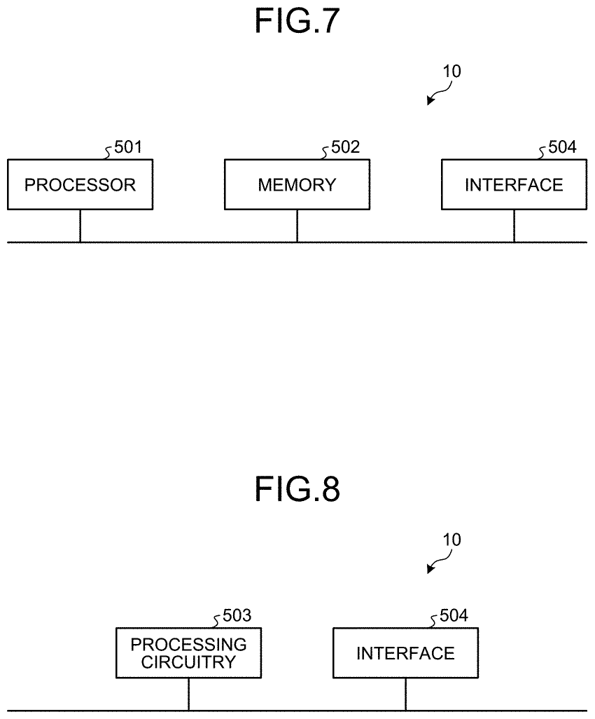

A hardware configuration of a computer that operates the engineering tool 10 will be described. FIG. 7 is a diagram illustrating a first example of a hardware configuration that implements a computer that operates the engineering tool according to the embodiment. FIG. 8 is a diagram illustrating a second example of a hardware configuration that implements a computer that operates the engineering tool according to the embodiment.

A computer that operates the engineering tool 10 can be implemented by a processor 501, a memory 502, and an interface 504 illustrated in FIG. 7. The processor 501 is a central processing unit (CPU, also referred to as a field-programmable gate array (FPGA), a central processing device, a processing device, a computation device, a microprocessor, a microcomputer, a processor, or a digital signal processor (DSP)), a system large scale integration (LSI), or the like. The memory 502 is a random access memory (RAM), a read only memory (ROM), or the like.

The memory 502 stores a program for executing the functions of the engineering tool 10. The processor 501 reads and executes the program stored in the memory 502 to thereby execute processing by the engineering tool 10. It can also be said that the program stored in the memory 502 causes the computer to execute a plurality of instructions corresponding to the procedure or method carried out by the engineering tool 10. The memory 502 is also used as a temporary memory when the processor 501 performs various processes.

The program executed by the processor 501 can be a computer program product having a computer-readable non-transitory recording medium including a plurality of computer-executable instructions for performing data processing. That is, the engineering tool 10 can be implemented by a computer-readable medium in which a program is recorded.

Note that the processor 501 and the memory 502 illustrated in FIG. 7 can be replaced with processing circuitry 503 illustrated in FIG. 8. For example, the processing circuitry 503 is a single circuit, a composite circuit, a programmed processor, a parallel programmed processor, an application specific integrated circuit (ASIC), a field-programmable gate array (FPGA), or a combination thereof. Note that a part of the functions of the engineering tool 10 can be implemented by dedicated hardware, and the other functions can be implemented by software or firmware.

In addition, at least one of the application 20, the platform 30, and the communication server 40 can be implemented by a hardware configuration similar to that of the computer that operates the engineering tool 10.

The configurations described in the above-mentioned embodiment indicate examples of the contents of the present invention. The configurations can be combined with another well-known technique, and some of the configurations can be omitted or changed in a range not departing from the gist of the present invention.

### REFERENCE SIGNS LIST

1 data collection system; 10 engineering tool; 11 device model editing unit; 12 conversion candidate providing unit; 13 device profile output unit; 20 application; 30 platform; 31 collection data setting unit; 32 collection data accumulation unit; 40 communication server; 41 device model management unit; 42 collection data generation unit; 50 device; 51 device data output unit; 60 network line; 71 data acquisition unit; 72 state observation unit; 73 learning unit; 121 data selection unit; 122 conversion rule learning unit; 123 conversion candidate estimation unit; 124 device model correction unit; 501 processor; 502 memory; 503 processing circuit; 504 interface; T1 to T3 conversion candidate; X1 to Xp input layer; Y1 to Yq intermediate layer; Z1 to Zr output layer.

1. A non-transitory storage medium to store a program which when executed by a processor causes the processor to perform:
an editing process of editing first correspondence information on a basis of an instruction from a first user, the first correspondence information indicating a correspondence between a first device-specific data type and a first reference data type, the first device-specific data type being a data type of first collection data to be collected from a first device, the first reference data type being a data type of first reference data interpretable by a first application; and
a conversion candidate providing process of learning a conversion rule on the basis of a result of editing of the first correspondence information, the conversion rule being a rule of conversion from the first reference data type to the first device-specific data type, and estimate, using the conversion rule, conversion candidates for a second device-specific data type with respect to a second reference data type, the second device-specific data type being a data type of second collection data to be collected from a second device, the second reference data type being a data type of second reference data interpretable by a second application.

2. The storage medium according to claim 1, wherein
the editing process edits the first correspondence information on the basis of first system information, the first system information being information including at least one of: first device information that is information on the first device; a kind of a first communication protocol corresponding to the first device; and a kind of the first application, and
the conversion candidate providing process estimates the conversion candidates on the basis of second system information, the second system information being information including at least one of: second device information that is information on the second device; a kind of a second communication protocol corresponding to the second device; and a kind of the second application.

3. The storage medium according to claim 2, wherein
the first device information includes at least one of: a kind of a device manufacturer that manufactured the first device; a kind of the first device; and a configuration of the first device, and
the second device information includes at least one of: a kind of a device manufacturer that manufactured the second device; a kind of the second device; and a configuration of the second device.

4. The storage medium according to claim 2, wherein
the conversion candidate providing process includes
a conversion rule learning process of learning the conversion rule, and
the conversion rule learning process includes:
a state observation process of observing state variables including the first system information and the first reference data type;
a data acquisition process of acquiring the first device-specific data type; and
a learning process of learning the conversion rule in accordance with a data set created based on combinations of the state variables and the first device-specific data type.

5. The storage medium according to claim 1, wherein
When a second user selects, from among the conversion candidates, the second device-specific data type corresponding to the second reference data type,
the editing process edits second correspondence information indicating a correspondence between the selected second device-specific data type and the second reference data type, and
the conversion candidate providing process relearns the conversion rule on the basis of a result of editing of the second correspondence information.

6. The storage medium according to claim 1, wherein
the first correspondence information is information corresponding to a device schema definition and a reference schema definition, the device schema definition indicating a schema definition of the first collection data, the reference schema definition indicating a schema definition of the first reference data.

7. A learning device comprising:
state observation circuitry to observe state variables when correspondence information is edited on a basis of an instruction from a user, the correspondence information indicating a correspondence between a device-specific data type and a reference data type, the device-specific data type being a data type of collection data to be collected from a device, the reference data type being a data type of reference data interpretable by an application, the state variables including: the reference data type included in the correspondence information; and system information that is information referred to during editing of the correspondence information;
data acquisition circuitry to acquire the device-specific data type included in the correspondence information; and
learning circuitry to learn a conversion rule in accordance with a data set, the data set being created based on combinations of the state variables and the device-specific data type, the conversion rule being a rule of conversion from the reference data type to the device-specific data type.

8. A data collection system comprising:
a communication server to collect collection data from one or more devices;
one or more applications to calculate, on a basis of the collection data, state information on a facility in which the one or more devices are placed;
a platform to acquire, from the communication server, collection data corresponding to data requested by the one or more applications, on the basis of correspondence information, and transmit the collection data to the one or more applications, the correspondence information indicating a correspondence between a device-specific data type and a reference data type, the device-specific data type being a data type of the collection data, the reference data type being a data type of reference data interpretable by the one or more applications; and
processing circuitry to edit the correspondence information on the basis of an instruction from one or more users, wherein
the processing circuitry includes:
editing circuitry to edit correspondence information on the basis of an instruction from a first user of the one or more users, the correspondence information indicating a correspondence between a first device-specific data type and a first reference data type, the first device-specific data type being a data type of first collection data to be collected from a first device of the one or more devices, the first reference data type being a data type of first reference data interpretable by a first application of the one or more applications; and
conversion candidate providing circuitry to learn a conversion rule on the basis of a result of editing of the correspondence information, and estimate, using the conversion rule, conversion candidates for a second device-specific data type with respect to a second reference data type, the conversion rule being a rule of conversion from the first reference data type to the first device-specific data type, the second device-specific data type being a data type of second collection data to be collected from a second device of the one or more devices, the second reference data type being a data type of second reference data interpretable by a second application of the one or more applications.

9. The data collection system according to claim 8, wherein
the conversion candidate providing circuitry sends the conversion candidates to the editing circuitry, and
when a second user of the one or more users selects, from among the conversion candidates, the second device-specific data type corresponding to the second reference data type,
the editing circuitry edits second correspondence information indicating a correspondence between the selected second device-specific data type and the second reference data type, and
the platform acquires, from the communication server, collection data corresponding to data requested by the second application, on the basis of the correspondence information sent from the editing circuitry, and transmits the collection data to the second application.

10. The storage medium according to claim 2, wherein
when a second user selects, from among the conversion candidates, the second device-specific data type corresponding to the second reference data type,
the editing process edits second correspondence information indicating a correspondence between the selected second device-specific data type and the second reference data type, and
the conversion candidate providing process relearns the conversion rule on the basis of a result of editing of the second correspondence information.

11. The storage medium according to claim 3, wherein
when a second user selects, from among the conversion candidates, the second device-specific data type corresponding to the second reference data type,
the editing process edits second correspondence information indicating a correspondence between the selected second device-specific data type and the second reference data type, and
the conversion candidate providing process relearns the conversion rule on the basis of a result of editing of the second correspondence information.

12. The storage medium according to claim 4, wherein
when a second user selects, from among the conversion candidates, the second device-specific data type corresponding to the second reference data type,
the editing process edits second correspondence information indicating a correspondence between the selected second device-specific data type and the second reference data type, and
the conversion candidate providing process relearns the conversion rule on the basis of a result of editing of the second correspondence information.

13. The storage medium according to claim 2, wherein
the first correspondence information is information corresponding to a device schema and a reference schema, the device schema definition indicating a schema definition of the first collection data, the reference schema definition indicating a schema definition of the first reference data.

14. The storage medium according to claim 3, wherein
the first correspondence information is information corresponding to a device schema and a reference schema, the device schema definition indicating a schema definition of the first collection data, the reference schema definition indicating a schema definition of the first reference data.

15. The storage medium according to claim 4, wherein
the first correspondence information is information corresponding to a device schema and a reference schema, the device schema definition indicating a schema definition of the first collection data, the reference schema definition indicating a schema definition of the first reference data.

16. The storage medium according to claim 5, wherein
the first correspondence information is information corresponding to a device schema and a reference schema, the device schema definition indicating a schema definition of the first collection data, the reference schema definition indicating a schema definition of the first reference data.

17. The storage medium according to claim 10, wherein
the first correspondence information is information corresponding to a device schema and a reference schema, the device schema definition indicating a schema definition of the first collection data, the reference schema definition indicating a schema definition of the first reference data.

18. The storage medium according to claim 11, wherein
the first correspondence information is information corresponding to a device schema and a reference schema, the device schema definition indicating a schema definition of the first collection data, the reference schema definition indicating a schema definition of the first reference data.

19. The storage medium according to claim 12, wherein
the first correspondence information is information corresponding to a device schema and a reference schema, the device schema definition indicating a schema definition of the first collection data, the reference schema definition indicating a schema definition of the first reference data.
